(19) United States
(12) Patent Application Publication
(10) Pub. No.: US 2010/0146332 A1
(43) Pub. Date: Jun. 10, 2010

(54) DATA CORRECTION CIRCUIT AND SEMICONDUCTOR INTEGRATED CIRCUIT

(75) Inventor: Yoshihisa Arai, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/610,476

(22) Filed: Nov. 2, 2009

(30) Foreign Application Priority Data
Dec. 10, 2008 (JP) 2008-314582

(51) Int. Cl. G06F 11/14

(52) U.S. Cl. 714/6; 714/E11.118

(57) ABSTRACT

A data correction circuit according to an embodiment of the present invention is configured to correct data stored in a non-rewritable nonvolatile memory. The correction circuit includes an address register configured to store an address indicating a correction point of the nonvolatile memory, a data register configured to store correction data for the nonvolatile memory, a comparator configured to compare a read address indicating a read position from the nonvolatile memory and the address stored in the address register, and to output a comparison result of the read address and the address stored in the address register, and a selector configured to select one of read data from the nonvolatile memory and the correction data stored in the data register, according to the comparison result, and to output the selected data.

### CROSS REFERENCE TO RELATED APPLICATION

This application is based upon and claims the benefit of priority from the prior Japanese Patent Application No. 2008-314582, filed on Dec. 10, 2008, the entire contents of which are incorporated herein by reference.

### BACKGROUND OF THE INVENTION

1. Field of the Invention

The present invention relates to a data correction circuit and a semiconductor integrated circuit, for example, to a semiconductor integrated circuit including a processor and a non-rewritable nonvolatile memory, and a data correction circuit for the nonvolatile memory.

2. Background Art

In many cases, an LSI provided with a processor uses a rewritable nonvolatile memory such as a NOR flash memory to retain a command code and a factor. From a viewpoint of reducing a cost and a number of components of an electronic device on which the LSI is mounted, the nonvolatile memory is preferably incorporated in the LSI. However, from viewpoints of a circuit area, a production process, and a production cost of the LSI, there are some difficult points in that the rewritable nonvolatile memory is incorporated in the LSI. Therefore, it is advantageous in cost that the command code and the factor are retained in a mask ROM incorporated in the LSI.

However, when the command code and the factor are retained in the mask ROM, a cost and a time for re-fabricating the mask and re-manufacturing the LSI are required in case where an error exists in ROM data.

In some cases, a processor has a patch mechanism against bugs of a program, such as generating an interruption while a program address is specified, or replacing a command by a dedicated circuit. It is necessary that the interruption mechanism and the command replacing mechanism be incorporated in the processor. However, it is difficult to add a function to an existing processor. Furthermore, in such cases, it is necessary that a determined mechanism specific to the processor be mounted on the LSI, so that it is difficult to impart flexibility to the mechanism for writing a patch program and the like.

For example, U.S. Pat. No. 6,260,157 discloses a processing device including a ROM in which a program command and a jump command are stored, a patch program for patching the program command in the ROM, a RAM in which the patch program can be stored, and a patch vector table indicating a location of the patch program.

For example, U.S. Pat. No. 6,438,664 discloses a processor provided with a RAM for microcode patching.

### SUMMARY OF THE INVENTION

An aspect of the present invention is, for example, a data correction circuit for correcting data stored in a non-rewritable nonvolatile memory, the correction circuit including an address register configured to store an address indicating a correction point of the nonvolatile memory, a data register configured to store correction data for the nonvolatile memory, a comparator configured to compare a read address indicating a read position from the nonvolatile memory and the address stored in the address register, and to output a comparison result of the read address and the address stored in the address register, and a selector configured to select one of read data from the nonvolatile memory and the correction data stored in the data register, according to the comparison result, and to output the selected data.

Another aspect of the present invention is, for example, a semiconductor integrated circuit including a processor, the integrated circuit including a non-rewritable nonvolatile memory in which data for the processor is stored, and a memory control circuit configured to control access to the nonvolatile memory, the control circuit including an address register configured to store an address indicating a correction point of the nonvolatile memory, a data register configured to store correction data for the nonvolatile memory, a comparator configured to compare a read address indicating a read position from the nonvolatile memory and the address stored in the address register, and to output a comparison result of the read address and the address stored in the address register, and a selector configured to select one of read data from the nonvolatile memory and the correction data stored in the data register, according to the comparison result, and to output the selected data.

### BRIEF DESCRIPTION OF THE DRAWINGS

FIG. 1 is a block diagram illustrating a configuration of a semiconductor integrated circuit according to a first embodiment;

FIG. 2 is a block diagram illustrating a configuration of a ROM controller according to the first embodiment;

FIG. 3 is a flowchart illustrating a ROM data correction processing in the first embodiment;

FIG. 4 is a block diagram illustrating a configuration of a semiconductor integrated circuit according to a modification of the first embodiment;

FIG. 5 is a block diagram illustrating a configuration of a ROM controller according to a second embodiment;

FIG. 6 is a block diagram illustrating a configuration of a semiconductor integrated circuit according to a third embodiment;

FIG. 7 is a block diagram illustrating a configuration of a ROM controller according to the third embodiment;

FIG. 8 is a flowchart illustrating a ROM data correction processing in the third embodiment;

FIG. 9 is a block diagram illustrating a configuration of a semiconductor integrated circuit according to a modification of the third embodiment; and

FIG. 10 is a block diagram illustrating a configuration of a ROM controller according to a fourth embodiment.

### DESCRIPTION OF THE EMBODIMENTS

Embodiments of the present invention will be described with reference to the drawings.

### First Embodiment

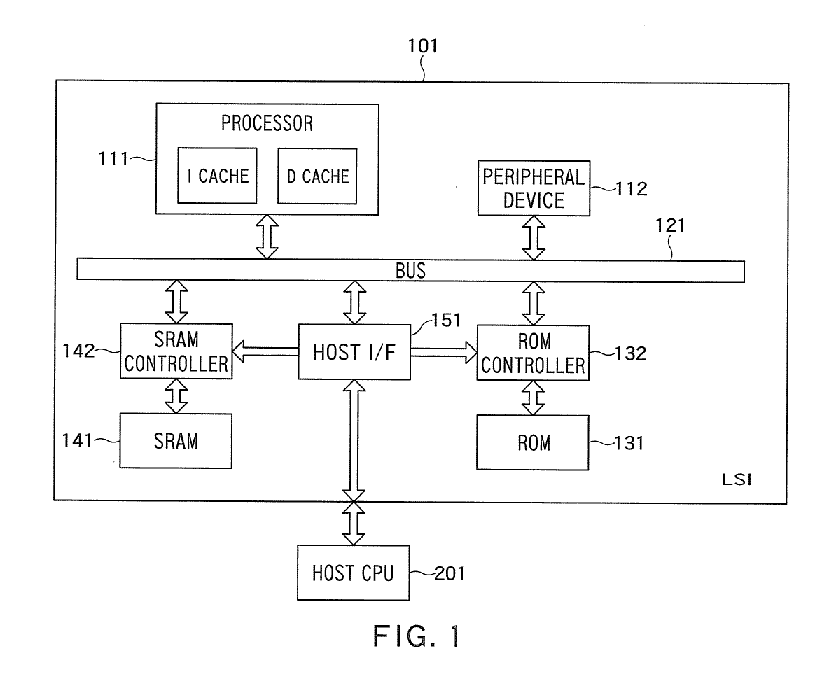

FIG. 1 is a block diagram illustrating a configuration of a semiconductor integrated circuit 101 according to a first embodiment.

Referring to FIG. 1, the semiconductor integrated circuit 101 includes a processor 111 and various peripheral devices 112. In this way, the processor 111 is incorporated in the semiconductor integrated circuit 101 in FIG. 1. The processor 111 and the peripheral devices 112 are connected to a bus 121 in the semiconductor integrated circuit 101. An I cache and a D cache are provided in the processor 111.

The semiconductor integrated circuit 101 of FIG. 1 also includes a ROM (Read Only Memory) 131, a ROM controller 132, a SRAM (Static Random Access Memory) 141, and an SRAM controller 142. The ROM 131 and the SRAM 141 are connected to the bus 121 through the ROM controller 132 and SRAM controller 142, respectively.

Data for the processor 111, such as a command code and a factor, are stored in the ROM 131. The ROM 131 of FIG. 1 is a mask ROM, and is an example of a non-rewritable nonvolatile memory of the invention. The ROM controller 132 controls access to the ROM 131. The ROM controller 132 is an example of a data correction circuit and a memory control circuit of the invention. Similarly, the SRAM controller 142 controls access to the SRAM 141. The SRAM 141 and the SRAM controller 142 are examples of a volatile memory and a memory control circuit for the volatile, memory of the invention, respectively.

The semiconductor integrated circuit 101 of FIG. 1 also includes a host I/F (Interface) 151. The host I/F 151 is used as an interface between the semiconductor integrated circuit 101 and a host CPU (Central Processing Unit) 201 located outside the semiconductor integrated circuit 101. The host I/F 151 is connected to the bus 121 as shown in FIG. 1.

The semiconductor integrated circuit 101 of FIG. 1 is an LSI (Large Scale Integrated Circuit). Hereinafter, the semiconductor integrated circuit 101 of FIG. 1 is referred to as an LSI 101.

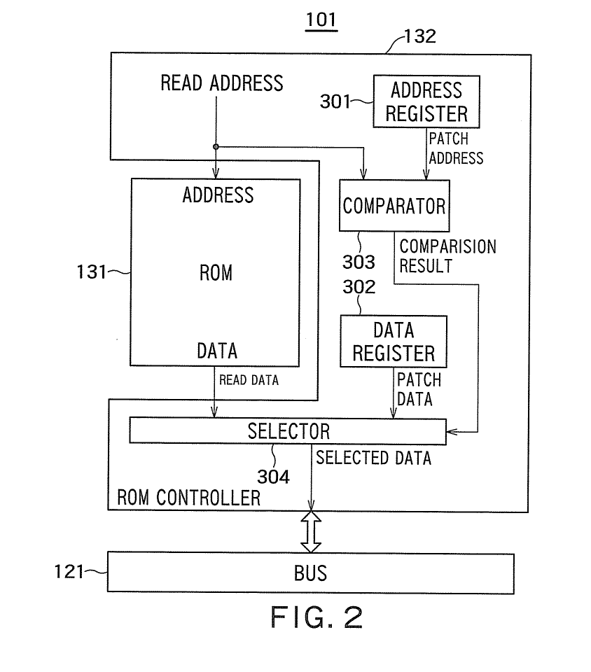

FIG. 2 is a block diagram illustrating a configuration of the ROM controller 132 of FIG. 1.

In the first embodiment, the ROM controller 132 has a function of correcting ROM data. As blocks playing a role of correcting the ROM data, the ROM controller 132 includes an address register 301, a data register 302, a comparator 303, and a selector 304.

The address register 301 is to be used to store a patch address indicating a correction point of the ROM 131. The data register 302 is to be used to store patch data for the ROM 131. The patch address stored in the address register 301 indicates a point to which the patch data stored in the data register 302 is applied. The patch address and the patch data are examples of the address and the correction data of the invention.

When a system provided with the LSI 101 is booted, the host CPU 201 stores the patch address and the patch data, in the address register 301 and the data register 302, respectively, and then boots the processor 111. At this time, the host CPU 201 accesses the LSI 101 through the host I/F 151. The patch address and the patch data are stored before the processor 111 is booted, so that a code having a bug can be prevented from being performed before patch processing.

Alternatively, when the system is booted, the processor 111 may determine whether patch information exists in its start routine. For example, it is assumed that the host CPU 201 sets the patch information in a predetermined register. The processor 111 then stores the patch address and the patch data in the address register 301 and the data register 302 respectively if needed, and makes a transition to the subsequent processing routine. Thereby, the code having the bug can be prevented from being performed before the patch processing. This method has a merit that a mechanism in which the host CPU 201 accesses the address register 301 and the data register 302 is not needed.

The comparator 303 compares a read address indicating a read position from the ROM 131 and the patch address stored in the address register 301, and outputs a comparison result of the read address and the patch address. The comparison result indicates whether the read address and the patch address are matched with each other. The comparison result is fed into the selector 304.

The selector 304 selects one of the read data from the ROM 131 and the patch data stored in the data register 302, according to the comparison result, and outputs the selected data. When the comparison result is “mismatch”, the selector 304 outputs the read data. On the other hand, when the comparison result is “match” the selector 304 outputs the patch data. The outputted data is transferred to the bus 121.

In this way, in this embodiment, the error of the ROM data can be corrected. In this embodiment, the function of correcting the ROM data is possessed by not the processor 111 but the ROM controller 132. As described above, the function is hardly added to the existing processor. On the other hand, in this embodiment, the ROM controller 132 has the function of correcting the ROM data, so that the function of correcting the ROM data can relatively easily be mounted on the LSI 101. In this embodiment, for example, advantageously any processor can be used as the processor 111. This is because it is not necessary to add the function of correcting the ROM data to the processor 111.

In this embodiment, the function of correcting the ROM data is realized by the address register 301, the data register 302, the comparator 303, and the selector 304. In this way, the function of correcting the ROM data can be realized by the simple circuit configuration in this embodiment.

In this embodiment, the ROM data is corrected by not rewriting the data in the ROM 131 but replacing the read data with the patch data, so that the ROM data can be corrected even if the ROM 131 is a mask ROM.

Thereby, the ROM data can be corrected even if the data for the processor 111 is retained in the mask ROM 131 incorporated in the LSI 101. Therefore, this embodiment has both the advantage of the mask ROM (such as the advantages in a circuit area, a production process, and a production cost of the LSI 101) and the advantage of the function of correcting the ROM data that the re-fabrication of the mask or the re-manufacture of the LSI 101 is not needed when the error exists in the ROM data. Accordingly, a cost and a time for re-fabricating the mask or re-manufacturing the LSI 101 are not required in this embodiment.

Referring to FIG. 1, an example of the ROM data correction processing will be described.

In order to suppress an increase of a circuit scale of the ROM controller 132, the correction of the ROM data is realistically performed by the one word. In such cases, when the command code in the ROM 131 is patched, the ROM controller 132 replaces a head of the correction point by a jump command to an SRAM region. In this case, the address of the head of the correction point becomes the patch address, and the jump command to the SRAM region becomes the patch data.

On the other hand, when the system is booted, the host CPU 201 stores the correction code for the command code of the ROM 131 in the SRAM 141, and stores the patch address and the patch data in the address register 301 and the data register 302, respectively. After the jump command, this correction code is executed from the SRAM 141. When the correction code processing is ended, the jump to the ROM region is made again. In this way, the ROM data correction processing is completed.

The host CPU 201 accesses the LSI 101 through the host I/F 151, when the correction code is stored in the SRAM 141.

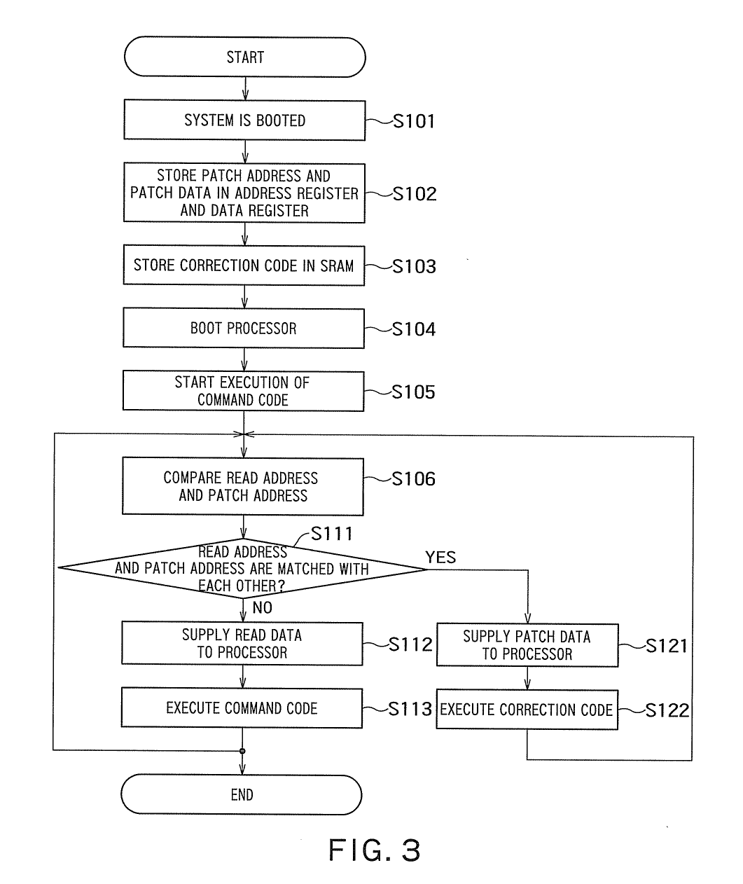

FIG. 3 is a flowchart illustrating the ROM data correction processing in the first embodiment. Reference numerals in the following description are identical to those of FIGS. 1 and 2.

In the first embodiment, when the system provided with the LSI 101 is booted (Step S101), the host CPU 201 stores the patch address and the patch data in the address register 301 and the data register 302, respectively (Step S102), and stores the correction code in the SRAM 141 (Step S103). Next, the host CPU 201 boots the processor 111 (Step S104). When the processor 111 is booted, for example, an initial boot code is booted from the ROM 131, and a basic code such as an OS (Operating System) is expanded in the SRAM 141 or an external memory of the LSI 101 from an external nonvolatile memory (for example, NOR flash memory) of the LSI 101 by the initial boot code, and then executed.

Then, the processor 111 accesses the ROM 131 through the ROM controller 132 to start the execution of the command code stored in the ROM 131 (Step S105). For example, the command code is an execution code in an application program running on the OS. A part of the application program running on the OS is stored in the ROM 131, and the part is executed as needed in a form of a library routine. When the command code is executed, the ROM controller 132 compares the read address indicating the read position from the ROM 131 and the patch address stored in the address register 301 (Step S106).

When the read address and the patch address are not matched with each other (NO in Step S111), the ROM controller 132 supplies the read address from the ROM 131 to the processor 111 (Step S112). Then, the processor 111 executes the command code in the ROM 131 (Step S113).

On the other hand, when the read address and the patch address are matched with each other (YES in Step S111), the ROM controller 132 supplies the patch data stored in the data register 302 to the processor 111 (Step S121). In the first embodiment, the patch address indicates the head of the correction point in the ROM 131, and the patch data is the jump command to the SRAM 141. Therefore, when the read address and the patch address are matched with each other, the ROM controller 132 selects and outputs the patch data, thereby replacing the command code of the head of the correction point by the jump command to the SRAM 141. When the processor 132 receives the patch data, the processor 132 executes the correction code in the SRAM 141 (Step S122). In this way, the command code in the ROM 131 is corrected with the correction code in the SRAM 141.

Generally, the library routine of the application program is not premised to be rewritten, and therefore the library routine is suitable to be stored in the ROM 131. Therefore, for example, the processing of FIG. 3 is useful to be applied to the bug of the library routine stored in the ROM 131.

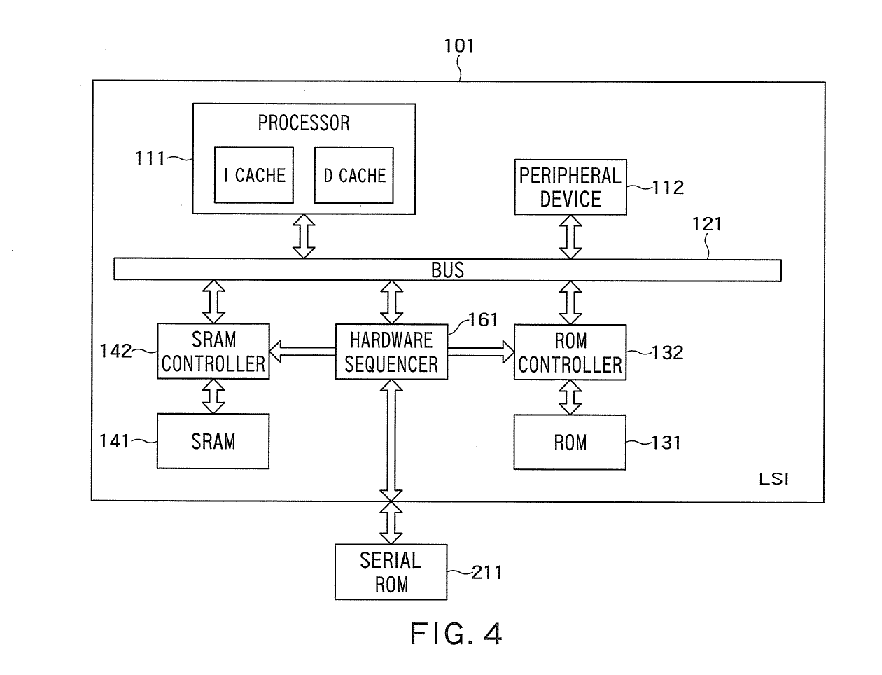

FIG. 4 is a block diagram illustrating a configuration of a modification of the LSI 101 in FIG. 1. The LSI 101 in FIG. 1 includes the host I/F 151, whereas the LSI 101 in FIG. 4 includes a hardware sequencer 161.

The hardware sequencer 161 can read data from a serial ROM 211 located outside the LSI 101. The serial ROM 211 is an example of the external memory of the invention. Instead of the serial ROM, a parallel ROM may be used as the external memory. As illustrated in FIG. 4, the hardware sequencer 161 is connected to the bus 121.

In the LSI 101 of FIG. 4, when the system is booted, the hardware sequencer 161 is initially booted. The hardware sequencer 161 reads the patch address, the patch data, and the correction code from the serial ROM 211, and stores the patch address, the patch data, and the correction code in the address register 301, the data register 302, and the SRAM 141, respectively. It is assumed that the patch address, the patch data, and the correction code are previously stored in the serial ROM 211.

In this way, in the LSI 101 of FIG. 1, the processing for storing the patch address, the patch data, and the correction code is performed by the external host CPU 201, whereas in the LSI 101 of FIG. 4, the processing for storing the patch address, the patch data, and the correction code is performed by the internal hardware sequencer 161. In the LSI 101 of FIG. 4, the processing for storing the patch address, the patch data, and the correction code can be performed without the aid of the external host CPU 201. Therefore, the LSI 101 of FIG. 4 has an advantage that the host CPU 211 is not needed thereby improving a degree of freedom of a configuration of the system.

As described above, in this embodiment, the function of correcting the ROM data is realized by the ROM controller 132 in the LSI 101 in which the processor 111 and the mask ROM 131 are incorporated. Thereby, this embodiment can provide the LSI 101 in which the correction data is allocated with the simple circuit when the error exists in the ROM data.

Semiconductor integrated circuits 101 according to second to fourth embodiments will be described below. The second to fourth embodiments are modifications of the first embodiment, and the aspects of the second to fourth embodiments that differ from the first embodiment are mainly described below.

### Second Embodiment

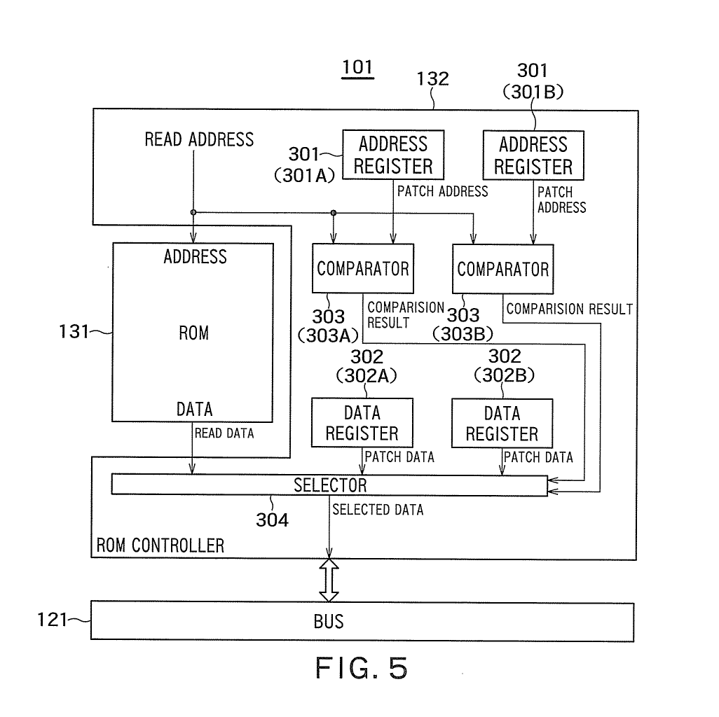

FIG. 5 is a block diagram illustrating a configuration of a ROM controller 132 according to a second embodiment. The ROM controller 132 of the second embodiment may be provided in the LSI 101 of FIG. 1 or the LSI 101 of FIG. 4.

In the second embodiment, as with the first embodiment, the ROM controller 132 has the function of correcting the ROM data. As blocks playing a role of correcting the ROM data, the ROM controller 132 of FIG. 5 includes N address registers 301, N data registers 302, N comparators 303, and a selector 304, where N is an integer of 2 or more, and is set to two in the second embodiment.

FIG. 5 illustrates two address registers 301A and 301B, and two data registers 302A and 302B.

The address register 301A and the data register 302A are used in pairs. The patch address stored in the address register 301A indicates a point to which the patch data stored in the data register 302A is applied.

Similarly, the address register 301B and the data register 302B are used in pairs. The patch address stored in the address register 3018 indicates a point to which the patch data stored in the data register 302B is applied.

In this way, the ROM controller 132 of FIG. 5 includes N (in the second embodiment, two) sets of the address registers 301 and the data registers 302. Thereby, the ROM data for N points can be corrected in this embodiment. In this embodiment, although N is set to two, N may be set to an integer of at least three.

FIG. 5 also illustrates two comparators 303A and 303B.

The comparator 303A compares the read address indicating the read position from the ROM 131 and the patch address stored in the address register 301A to output a comparison result of the read address and the patch address. The comparator 303A is used in the comparison processing for the address register 301A.

Similarly, the comparator 303B compares the read address indicating the read position from the ROM 131 and the patch address stored in the address register 301B to output a comparison result of the read address and the patch address. The comparator 3038 is used in the comparison processing for the address register 301B.

In this way, the ROM controller 132 includes the N comparators 303, and each of the comparators 303 corresponds to one of the N address registers 301 and one of the N data registers 302. Thereby, in the second embodiment, the ROM data for N points can be corrected.

The comparison results are fed into the selector 304 from the comparators 303A and 303B.

The selector 304 selects the read data from the ROM 131, the patch data stored in the data register 302A, or the patch data stored in the data register 3028, according to the comparison results from the comparators 303A and 303B, and outputs the selected data.

When both the comparison results from the comparators 303A and 303B are “mismatch”, the selector 304 outputs the read data. On the other hand, when the comparison result from the comparator 303A is “match”, the selector 304 outputs the patch data stored in the data register 302A. Similarly, when the comparison result from the comparator 303B is “match”, the selector 304 outputs the patch data stored in the data register 302B.

The storage contents of each address register 301 and each data register 302 may be rewritten from the processor 111. Thereby, the patch address and the patch data can be set by the program executed by the processor 111, and a limitation of the number of the ROM data correction points can effectively be eliminated. What is described in this paragraph can be applied to not only the second embodiment but also the first embodiment.

As described above, in this embodiment, plural sets of the address registers 301 and the data registers 302 are provided in the ROM controller 132, so that the ROM data for plural points can be corrected.

### Third Embodiment

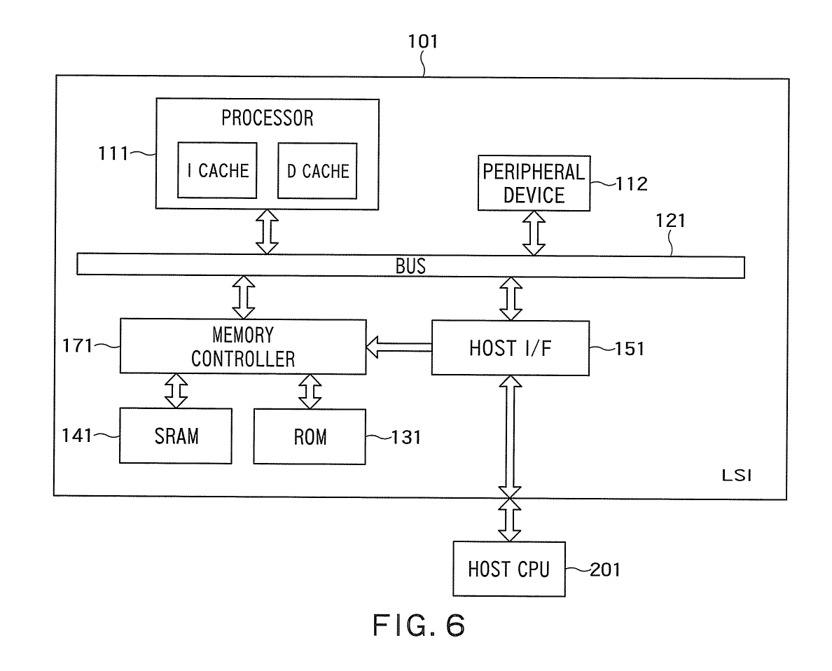

FIG. 6 is a block diagram illustrating a configuration of a semiconductor integrated circuit 101 according to a third embodiment. Hereinafter the semiconductor integrated circuit 101 of FIG. 6 is referred to as LSI 101.

The LSI 101 of FIG. 1 includes the ROM controller 132 and the SRAM controller 142, whereas the LSI 101 of FIG. 6 includes a memory controller 171.

In the third embodiment, the memory controller 171 controls the access to the ROM 131 and the access to the SRAM 141. The ROM 131 is an example of a non-rewritable nonvolatile memory of the invention, and the SRAM 141 is an example of a volatile memory of the invention. The memory controller 171 is an example of a data correction circuit and a memory control circuit of the invention. As illustrated in FIG. 6, the ROM 131 and the SRAM 141 are connected to the bus 121 through the memory controller 171.

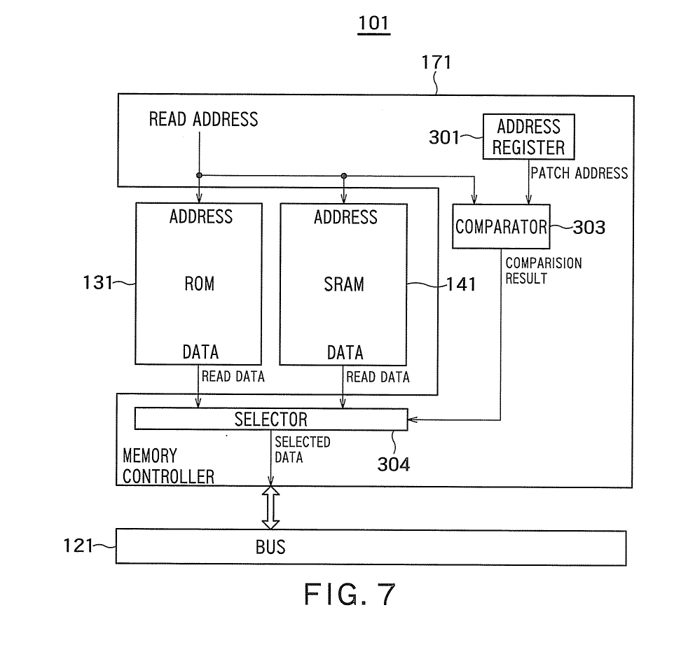

FIG. 7 is a block diagram illustrating a configuration of the memory controller 171 of FIG. 6.

In this embodiment, the memory controller 171 has the function of correcting the ROM data. Thereby, in the third embodiment, a degree of freedom of the command code correction processing can be enhanced compared with the first embodiment. As blocks playing a role of correcting the ROM data, the memory controller 171 includes the address register 301, the comparator 303, and the selector 304.

In this embodiment, the patch address indicating the correction point of the ROM 131 is stored in the address register 301. Further, the correction data for the ROM 131 is stored in the SRAM 141. An example of the correction data includes a correction code which is to be replaced with the command code in the ROM 131. The patch address stored in the address register 301 indicates a point to which the correction data stored in the SRAM 141 is applied.

When the system provided with the LSI 101 is booted, the host CPU 201 stores the patch address and the correction data in the address register 301 and SRAM 141 respectively, and then boots the processor 111. At this time, the host CPU 201 accesses the LSI 101 through the host I/F 151. Alternatively, as described above, when the system is booted, the processor 111 may determine whether the patch information exists in its start routine.

The comparator 303 compares the read address indicating the read position from the ROM 131 and the patch address stored in the address register 301, and outputs the comparison result of the read address and the patch address. The comparison result indicates whether the read address and the patch address are matched with each other. The outputted comparison result is fed into the selector 304.

The selector 304 selects one of the read data from the ROM 131 and the correction data stored in the SRAM 141 according to the comparison result, and outputs the selected data. When the comparison result is “mismatch”, the selector 304 outputs the read data. On the other hand, when the comparison result is “match”, the selector 304 outputs the correction data. The outputted data is transferred to the bus 121.

In this way, in the third embodiment, the error of the ROM data can be corrected. Because the memory controller 171 has the function of correcting the ROM data, the function of correcting the ROM data can relatively easily be mounted on the LSI 101, similar to the first embodiment.

In the third embodiment, the ROM data correction processing is performed by the memory controller 171 that can control the access to the SRAM 141. Therefore, the processing for replacing the command code in the ROM 131 by the correction code can be performed simpler than that in the first embodiment.

The patch address will be described below.

In the third embodiment, the correction data is stored in not the data register 302 but the SRAM 141. Therefore, it is not necessary that the address register 301 have all bits of the patch address. The address resister 301 may have only high-order bits of the patch address. In such cases, the comparator 303 compares high-order bits of the read address and the high-order bits of the patch address, and outputs a comparison result of them. When the high-order bits of the read address and the high-order bits of the patch address are matched with each other, the selector 304 outputs the correction data. Thereby, in an address region including the address having the high-order bits, all pieces of the ROM data are replaced by the correction data.

Storing only the high-order bits of the patch address in the address register 301 corresponds to storing an address region indicating the correction point in the address register 301. Further, the comparison of the high-order bits of the read address and the high-order bits of the patch address corresponds to a comparison of a read address region and an address region indicating the correction point. The high-order bits of the patch address is an example of an address region of the invention. The high-order bits of the read address is an example of a read address region of the invention.

According to such a correction processing by the region, pieces of the ROM data in a region can collectively be replaced by pieces of the correction data. For example, the processing is effectively used to correct a factor table.

In this embodiment, the correction data may be stored in not the RAM 141 provided in the LSI 101 but a RAM provided outside the LSI 101. An example of the RAM includes an SDRAM (Synchronous Dynamic RAM). The memory controller 171 controls access to the SDRAM. The SDRAM is an example of a volatile memory of the invention.

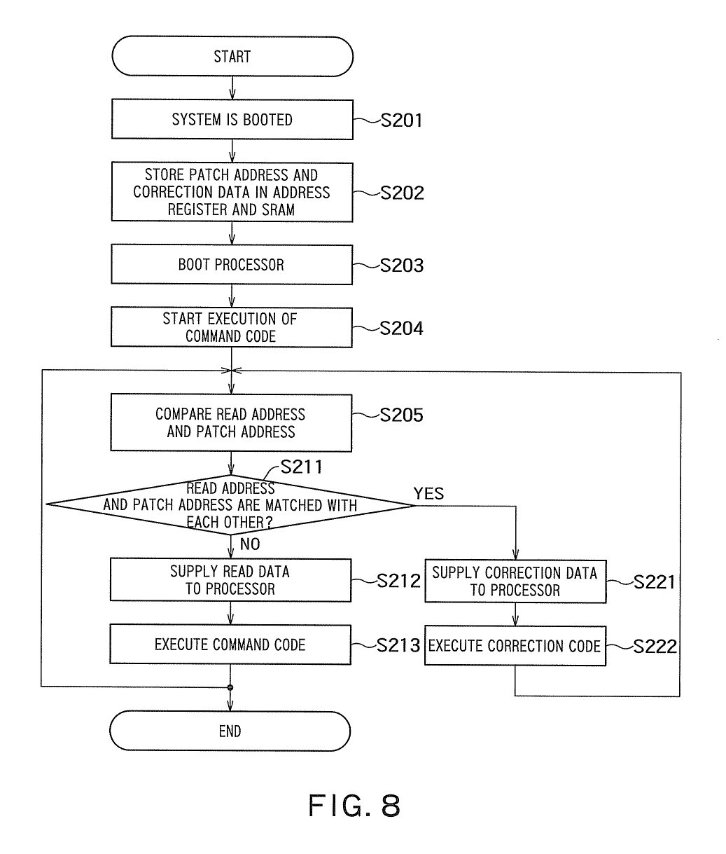

FIG. 8 is a flowchart illustrating the ROM data correction processing in the third embodiment. Reference numerals in the following description are identical to those of FIGS. 6 and 7.

When the system provided with the LSI 101 is booted (Step S201), the host CPU 201 stores the patch address and the correction data in the address register 301 and the SRAM 141, respectively (Step S202). Next, the host CPU 201 boots the processor 111 (Step S203). When the processor 111 is booted, for example, an initial boot code is booted from the ROM 131, and a basic code such as an OS is expanded in the SRAM 141 or an external memory of the LSI 101 from an external nonvolatile memory of the LSI 101 by the initial boot code, and is then executed.

Then, the processor 111 accesses the ROM 131 through the memory controller 171 to start the execution of the command code in the ROM 131 (Step S204). For example, the command code is an execution code in an application program running on the OS. A part of the application program running on the OS is stored in the ROM 131, and the part is executed as needed in a form of a library routine. When the command code is executed, the memory controller 171 compares the read address indicating the read position from the ROM 131 and the patch address stored in the address register 301 (Step S205).

When the read address and the patch address are not matched with each other (NO in Step S211), the memory controller 171 supplies the read address from the ROM 131 to the processor 111 (Step S212). In this way, the processor 111 executes the command code in the ROM 131 (Step S213).

On the other hand, when the read address and the patch address are matched with each other (YES in Step S211), the memory controller 171 supplies the correction data stored in the SRAM 141 to the processor 111 (Step S221). In this embodiment, the patch address is the address of the head of the correction point in the ROM 131, and the correction data is the correction data for the command code in the ROM 131. Therefore, when the read address and the patch address are matched with each other, the memory controller 171 selects and outputs the correction data, thereby replacing the command code of the correction point by the correction code in the SRAM 141. Then, the processor 132 executes the replaced correction code (Step S222). In this way, the command code in the ROM 131 is corrected by the correction code in the SRAM 141.

The flowchart of FIG. 8 can also be applied when an address region is used in the patch processing instead of the address.

In the third embodiment, ROM codes in a wide range can collectively be replaced by correction codes. The first embodiment is applied to a correction of a small range, for example, a correction of one function. On the other hand, in the third embodiment, the whole or a part of a library including plural functions can collectively be corrected.

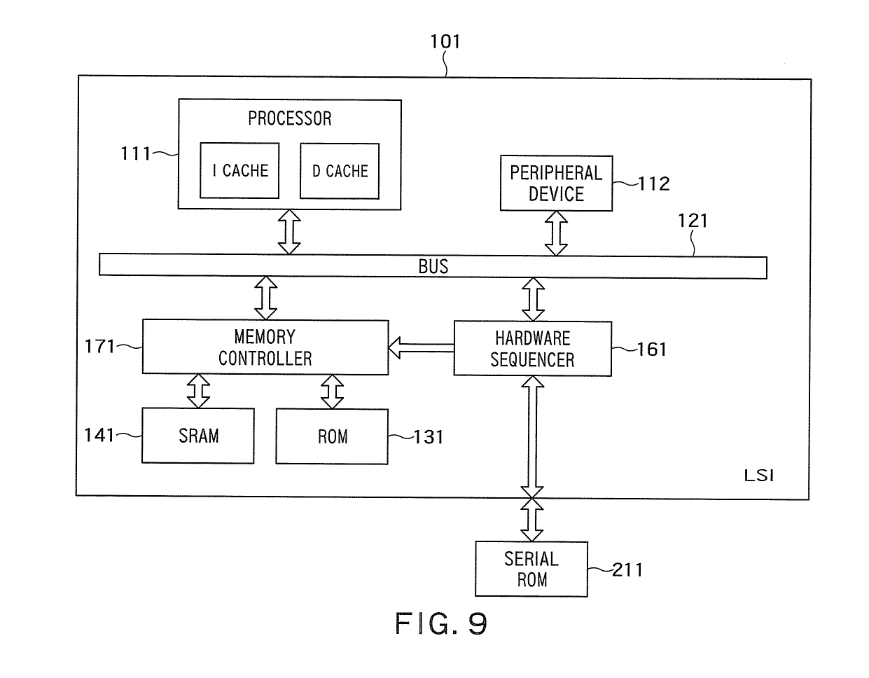

FIG. 9 is a block diagram illustrating a configuration of a modification of the LSI 101 in FIG. 6. The LSI 101 in FIG. 6 includes the host I/F 151, whereas the LSI 101 in FIG. 9 includes the hardware sequencer 161. The operation and advantage of the LSI 101 in FIG. 9 are similar to those of the LSI 101 in FIG. 4.

As described above, in this embodiment, the function of correcting the ROM data is realized by the memory controller 171 in the LSI 101 in which the processor 111 and the mask ROM 131 are incorporated. Thereby, this embodiment can provide the LSI 101 in which the correction data is allocated with the simple circuit when the error exists in the ROM data.

### Fourth Embodiment

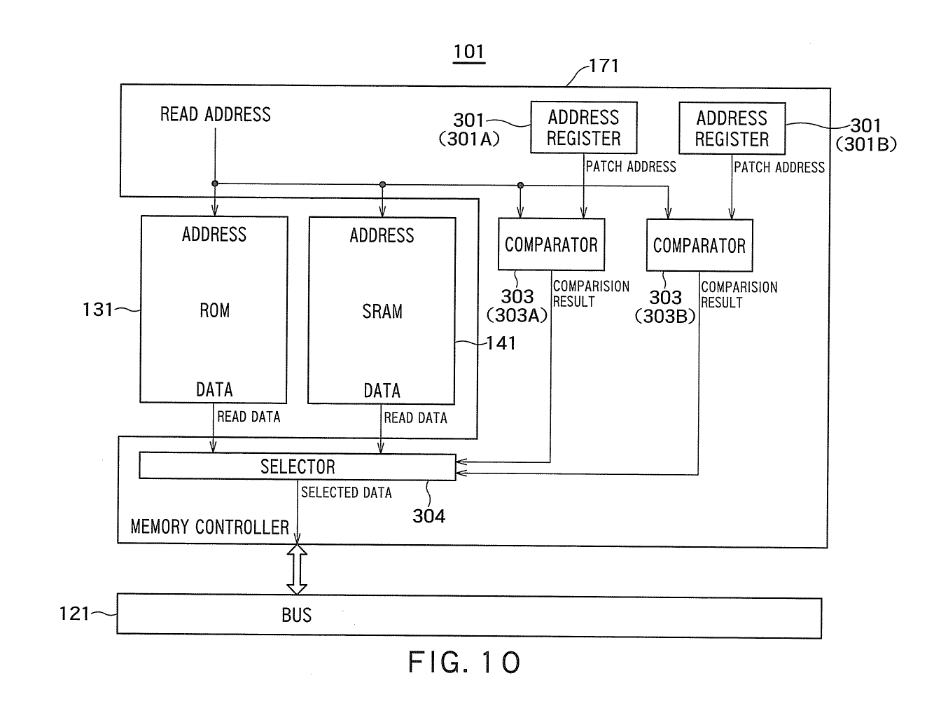

FIG. 10 is a block diagram illustrating a configuration of a memory controller 171 according to a fourth embodiment. The memory controller 171 of the fourth embodiment may be provided in the LSI 101 of FIG. 6 or the LSI 101 of FIG. 9.

In the fourth embodiment, as with the third embodiment, the memory controller 171 has the function of correcting the ROM data. As blocks playing a role of correcting the ROM data, the memory controller 171 of FIG. 10 includes N address registers 301, N comparators 303, and a selector 304, where N is an integer of at least two, and N is set to two in the fourth embodiment.

FIG. 10 illustrates two address registers 301A and 301B.

The patch addresses indicating the correction points of the ROM 131 are stored in the address registers 301A and 301B. The correction data for the ROM 131 is stored in the SRAM 141. The patch addresses stored in the address registers 301A and 301B indicate the points to which the correction data stored in the SRAM 141 is applied.

In this way, the memory controller 171 includes N (in the fourth embodiment, two) address registers 301, so that the ROM data can be corrected at N points. In the fourth embodiment, N is set to two. Alternatively, N may be set to an integer of at least three.

FIG. 10 also illustrates two comparators 303A and 303B. The comparator 303A compares the read address indicating the read position from the ROM 131 and the patch address stored in the address register 301A, and the outputs a comparison result of the read address and the patch address. The comparator 303A is used in a comparison processing for the address register 301A.

Similarly, the comparator 303B compares the read address indicating the read position from the ROM 131 and the patch address stored in the address register 301B, and outputs a comparison result of the read address and the patch address. The comparator 303B is used in a comparison processing for the address register 301B.

In this way, the memory controller 171 includes the N comparators 303, and each of the comparators 303 corresponds to one of the N address registers 301 and one of the N data registers 302. Thereby, in the fourth embodiment, the ROM data can be corrected at N points.

The comparison results are fed into the selector 304 from the comparators 303A and 303B.

The selector 304 selects one of the read data from the ROM 131 and the correction data stored in the SRAM 141 according to the comparison results from the comparators 303A and 303B, and outputs the selected data.

When both the comparison results from the comparators 303A and 303B are “mismatch”, the selector 304 outputs the read data. On the other hand, when the comparison result from the comparator 303A is “match”, the selector 304 outputs the correction data indicated by the patch address stored in the address register 301A. Similarly, when the comparison result from the comparator 303B is “match”, the selector 304 outputs the correction data indicated by the patch address stored in the address register 301B.

The address registers 301A and 301B may have only high-order bits of the patch addresses. In such cases, each of the comparators 303A and 303B compares the high-order bits of the read address and the high-order bits of the patch address, and outputs a comparison result of them. The selector 304 outputs the correction data when the high-order bits of the read address and the high-order bits of the patch address are matched with each other.

As described above, in the fourth embodiment, plural address registers 301 are provided in the memory controller 171, so that the ROM data can be corrected at plural points.

With regard to a semiconductor integrated circuit in which a processor and a non-rewritable nonvolatile memory are incorporated, the embodiments of the invention can provide the semiconductor integrated circuit in which correction data is allocated with a simple circuit when data error exists in the nonvolatile memory.

Further, the embodiments of the invention can provide a data correction circuit that can implement the semiconductor integrated circuit.

Although examples of specific aspects of the invention are described by the first to fourth embodiments, the invention is not limited to these embodiments.

1. A data correction circuit for correcting data stored in a non-rewritable nonvolatile memory, the correction circuit comprising:
an address register configured to store an address indicating a correction point of the nonvolatile memory;
a data register configured to store correction data for the nonvolatile memory;
a comparator configured to compare a read address indicating a read position from the nonvolatile memory and the address stored in the address register, and to output a comparison result of the read address and the address stored in the address register; and
a selector configured to select one of read data from the nonvolatile memory and the correction data stored in the data register, according to the comparison result, and to output the selected data.

2. The correction circuit according to claim 1, comprising, as the address resister, the data register, and the comparator, N address registers, N data registers, and N comparators (N is an integer of at least one).

3. The correction circuit according to claim 1, wherein each of the N comparators corresponds to one of the N address registers and one of the N data registers.

4. A semiconductor integrated circuit including a processor, the integrated circuit comprising:
a non-rewritable nonvolatile memory in which data for the processor is stored; and
a memory control circuit configured to control access to the nonvolatile memory, the control circuit comprising:
an address register configured to store an address indicating a correction point of the nonvolatile memory;
a data register configured to store correction data for the nonvolatile memory;
a comparator configured to compare a read address indicating a read position from the nonvolatile memory and the address stored in the address register, and to output a comparison result of the read address and the address stored in the address register; and
a selector configured to select one of read data from the nonvolatile memory and the correction data stored in the data register, according to the comparison result, and to output the selected data.

5. The integrated circuit according to claim 4, further comprising:
a host interface configured to serve as an interface between the integrated circuit and a host located outside the integrated circuit,
wherein the host stores the address indicating the correction point of the nonvolatile memory and the correction data, in the address register and the data register through the host interface, respectively.

6. The integrated circuit according to claim 5, wherein
the host stores the address indicating the correction point of the nonvolatile memory and the correction data, in the address register and the data register, respectively, when a system in which the integrated circuit is provided is booted.

7. The integrated circuit according to claim 6, wherein
the host boots the processor after storing the address indicating the correction point of the nonvolatile memory and the correction data, in the address register and the data register, respectively.

8. The integrated circuit according to claim 4, further comprising:
a hardware sequencer configured to read data from an external memory located outside the integrated circuit,
wherein the hardware sequencer reads the address indicating the correction point of the nonvolatile memory and the correction data, from the external memory, and stores the address indicating the correction point of the nonvolatile memory and the correction data, in the address register and the data register, respectively.

9. The integrated circuit according to claim 4, further comprising:
a volatile memory; and
another memory control circuit configured to control access to the volatile memory.

10. The integrated circuit according to claim 9, wherein
the volatile memory is to be used to store a correction code for a command code stored in the nonvolatile memory.

11. The integrated circuit according to claim 10, wherein
the address stored in the address register indicates a head of the correction point of the nonvolatile memory, and
the correction data stored in the data register is a jump command to the volatile memory.

12. The integrated circuit according to claim 11, wherein
the control circuit corrects a command code of the correction point with the correction code, by replacing the command code of the head of the correction point by the jump command.

13. The integrated circuit according to claim 4, wherein
the address stored in the address register is an address region indicating the correction point of the nonvolatile memory.

14. The integrated circuit according to claim 13, wherein
the comparator compares a read address region indicating a read position from the nonvolatile memory and the address region stored in the address register.
